(19) United States
(12) Patent Application Publication
(10) Pub. No.: US 2026/0200403 A1
(43) Pub. Date: Jul. 16, 2026

(54) A FOLDABLE ACCESS PLATFORM AND METHOD OF USE THEREOF

(71) Applicant: EKK HOLDINGS PTY LIMITED, Paget, Queensland (AU)

(72) Inventor: Eric NEILSEN, Queensland (AU)

(21) Appl. No.: 19/136,796

(22) PCT Filed: Dec. 5, 2023
(86) PCT No.: PCT/AU2023/051260

§ 371 Date: Jun. 6, 2025

(30) Foreign Application Priority Data
Dec. 6, 2022 (AU) 2022903718

(51) Int. Cl. B60R 3/00

(52) U.S. Cl. CPC B60R 3/005

(57) ABSTRACT

The present invention relates to an apparatus and method for deploying a foldable access platform directly on a dump truck for accessing a rear of a cab of the dump truck. The platform includes: a deck extending rearwardly from the rear of the cab; and at least one guard rail assembly having a lower end pivotally mountable to a rear edge of the deck and an upper end pivotable between a stowage position in which the upper end is folded against the rear of the cab and an operable position in which upper end extends substantially upwards from the deck.

### TECHNICAL FIELD

The present invention relates to an apparatus and method for deploying a foldable access platform directly on a dump truck. In particular, the present invention concerns a foldable access platform and method of use for accessing a rear of a cab of a dump truck.

### BACKGROUND

Dump trucks are typically used for transporting resources excavated at mine sites. Due to the volume of materials excavated, it is common for such dump trucks to have payload capacities up to 450 metric ton.

In such dump trucks, many of the on-vehicle electrical devices, such as, e.g., DC/DC converters, are integrated and stored in a control cabinet externally mounted on, or near, a rear of the cab of the dump truck.

The sheer size of such dump trucks presents numerous problems for technicians responsible for servicing such vehicles. For example, current best practice is for technicians to utilise ladders and/or elevated access platforms to gain access to the control cabinet.

A problem in general with such practice is that ladders and elevated access platforms are prone to movement relative to the truck and therefore pose a significant safety risk. This problem is particularly pronounced when maintenance is undertaken off-site on uneven ground surfaces.

Further problems with such practice are that it is generally inconvenient and time consuming to have to source and move ladders and elevated access platforms nearby whenever a dump truck is being serviced.

For example, in many instances mine sites can occupy vast areas of land, meaning there can be a significant distance between the mining site and a maintenance facility. In case an unexpected event happens and the technician has to access the control, it will be appreciated that it can take quite some time to arrange a ladder or lift to be delivered from a maintenance facility, which may be costly and result in unacceptable downtime.

Various access platforms have been designed to provide access to elevated sites.

For example, US Patent Publication No. 2015/224936A1 discloses an extendable personnel platform for use on a cargo truck with a foldable guardrail for permitting personnel to easily access a compartment and cargo through a body side door. However, the applicant has found such platforms to be overly complicated and not compatible with dump trucks.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a foldable access platform apparatus and method of use, which may at least partially address one or more of the problems or deficiencies mentioned above or which may provide the public with a useful or commercial choice.

According to first aspect of the present invention, there is provided a foldable access platform for accessing a rear of a cab of a dump truck, said platform including:
a deck extending rearwardly from the rear of the cabin; and
at least one guard rail assembly having a lower end pivotally mountable to a rear edge of the deck and an upper end pivotable between a stowage position in which the upper end is folded against the rear of the cab and an operable position in which upper end extends substantially upwards from the deck.

According to a second aspect of the present invention, there is provided a foldable access platform for accessing a rear of a cab of a dump truck, said platform including:
a deck pivotally mountable to a rear of the cabin, said deck pivotable between an operable position in which the deck extends rearwardly from the cab in a substantially horizontal orientation and a stowage position in which the deck pivots towards the cab to a substantially vertical orientation; and
at least one guard rail assembly having a lower end pivotally mountable to a rear edge of the deck and an upper edge pivotable relative to the deck when the deck pivots between the operable and stowage positions, said upper end configured to extend substantially upwards from the deck when the deck is in the operable position and fold against the rear of the cab when the deck is in the stowage position.

According to a third aspect of the present invention, there is provided a guard rail assembly for use with the foldable access platform of the first or second aspect, said assembly including:
a lower end pivotally mountable to a rear edge of the deck; and
an upper end pivotable relative to the deck between a stowage position in which the upper end folds against a rear of a cab to which the foldable access platform is mounted and an operable position in which the upper end extends substantially upwards from the deck.

Advantageously, the present invention provides an apparatus and a method for technicians to access the control cabinet to service internal components such as DC/DC convertors in the dump truck. The apparatus and method provide a convenient way for at least one technician to stand on a deck attached to the rear of the control cabinet without engaging a platform ladder or other personnel platform. The guard rail assembly is pivotably mounted on the edge of the deck providing a safety mechanism to ensure the technician is fully protected without worrying about slip and fall accidents. Further, the deck may be switched to a stowage position to minimise its storage space when it is not in an operable position. The guard rail assembly can be manually manipulated to be in a stowage or operable position. In its operable position, the guard rail assembly would be relatively orthogonal to the deck, while in the stowage position, the guard rail may be folded to an angle relatively to the deck. In turn, this reduces the occupied space of the whole apparatus in the dump truck and provides a flexible way to fit into the small space between the control cabinet and the dump box when it is not used by the technicians. Both the deck and guard rail assembly may be made from lightweight aluminium or other materials, so they can be directly installed on the control cab without changing it.

As indicated above, the foldable access platform of the present invention is for use in accessing a rear of a cab of a dump truck, preferably haul trucks or rigid dump trucks (e.g., Komatsu™ HD1500 or Liebherr™ T264, T274, T282 or T284). It will therefore be convenient to hereinafter describe the platform with reference to this example application. However, a person skilled in the art will appreciate that the access platform is capable of broader applications with any vehicle or structure requiring temporary foldable access in a restrictive space.

Generally, the dump truck includes a chassis, a cab and a dump truck body or tray hingedly coupled to the chassis and configured to pivot between a lowered position for receiving and transporting materials and a raised position for unloading the materials.

Preferably, the dump truck is a traditional dump truck, also known as a haul or rigid dump truck. Such dump trucks include a single rigid chassis on which both the cab and the dump truck body or tray are mounted, i.e., the cab at the front of the chassis and the dump truck body or tray behind the cab.

Typically, many on-vehicle electrical devices, such as DC/DC converters, are integrated and installed in a control cab mounted to, or adjacent, a rear of the cab of the dump truck. Usually, the control cab may be located between 2,000 mm and 4,000 mm above a ground surface.

As indicated, the platform includes a deck extending rearwardly from a rear of the cab. The deck may be of any suitable size, shape and construction and may be of constructed from any suitable material or materials to provide a platform for supporting a technician.

The deck may generally be formed from metal, preferably aluminium.

The deck may include a deck frame and one or more panels mounted atop the frame.

The deck frame may have a generally planar and elongate shape, preferably rectangular. The frame may include a front edge, an opposed rear edge and opposed side edges. The front and rear edges may extend longitudinally between the opposed side edges.

The deck frame may define an upper surface and an opposed lower surface. The one or more panels may be mounted atop the upper surface.

The deck frame may be formed from two or more frame members joined together. For example, the frame may include at least a pair of longitudinally extending frame members defining the front and rear edges and extending between the opposed side edges. The longitudinally extending frame members may be joined together by two or more transversely extending cross frame members defining at least the opposed side edges. The various frame members may be joined together using conventional welding techniques and/or with one or more mechanical fasteners.

The frame members may each be of tubular construction, solid construction, plate construction or any combination thereof, preferably tubular with a substantially rectangular cross section.

As mentioned, the deck frame may preferably have an elongate rectangular shape configured to extend width wise across the rear of cab of a dump truck.

The deck frame may have a length as defined between the opposed side edges of about 1.0 m, about 1.25 m, about 1.5 m, about 1.75 m, about 2.0 m, about 2.25 m, about 2.5 m, about 2.75 m or even about 3.0 m.

Likewise, the deck frame may have a width as defined between the front and rear edges of about 350 mm, about 400 mm, about 450 mm, about 500 mm, about 550 mm, about 600 mm, about 650 mm, about 700 mm, about 750 mm, or even about 800 mm.

The one or more panels mounted atop the deck frame may be joined to the frame members defining the upper surface using conventional welding techniques and/or with one or more mechanical fasteners.

In some embodiments, an upper surface of the one or more panels may include a liner or coating at least on a portion to provide grip.

In other embodiments, the upper surface of the one or more panels may include a textured tread to provide grip.

In yet other embodiments, the one or more panels may be formed from mesh, or include a mesh portion, to provide grip, preferably steel mesh.

In some embodiments, the deck may further include a guard extending upwardly from and extending at least partially about the opposed side edges and the rear edge. The guard may advantageously prevent any items inadvertently rolling or sliding over the rear and/or side edges of the deck.

The guard may preferably include one or more sheets of metal materials extending upwards from the opposed side edges and the rear edge to a height of about 50 mm, about 75 mm, about 100 mm, about 125 mm, about 150 mm, about 175 mm, about 200 mm or more. Preferably aluminium sheeting.

Like the frame members and the panels, the guard may be joined to the opposed side edges and the rear edge of the deck using conventional welding techniques and/or with one or more mechanical fasteners.

The deck may be mounted to a rear of the cab in any suitable way. For example, the deck may be fixedly or pivotally mountable to the rear of the cab. Likewise, the deck may be directed or indirectly mountable to the rear of the cab, preferably the latter.

In some embodiments, the deck may be mounted to a rear of the cab by one or more brackets extending between the rear of the cab and an underside of the deck, preferably at least two brackets. The brackets may be angle brackets or U-brackets, for example.

In some such embodiments, the brackets may be connectable to mounting points defined on the rear of the cab and the underside of the deck. For example, the brackets may be mounted to lifting points defined on the rear of the cab, typically adjacent each side edge of the deck. Likewise, each bracket may be connected to a pair of opposed lugs defined on an underside of the deck, typically protruding from one or more of the frame members, preferably the cross frame members, more preferably the outer cross frame members defining the respective side edges and at or near rear edge of the deck.

In other such embodiments, the brackets may be U-brackets extending down from an underside of the deck and configured to sit atop a support member extend across the rear of the cab. The support member may typically be in the form of beam, such as, e.g., a control box brace.

In such embodiments, the deck may include two or more U-brackets extending downwardly from, and spaced along the front edge of the deck, preferably from the longitudinally extending frame member defining the front edge.

The distal open ends of each U-bracket may preferably extend beyond the support member and be fastened about the support member with a mechanical fastener or the like.

In other embodiments, the deck may be mounted to a rear of the cab by one or more support arms extending between the rear of the cab and an underside of the deck, preferably at least two support arms, more preferably two support arms extending between the rear of the cab and an underside of the deck at either side edge of the deck.

Each support arm may include a pair of opposed ends and an elongate body extending therebetween.

Each end may be configured to be pivotally coupled to one of the rear of the cab and the underside of the deck, preferably mounting points defined on the rear of the cab and the underside of the deck.

For example, and as previously described, a first end of each support arm may be coupled to a lifting point defined on the rear of the cab and an opposed second end may be coupled to a pair of lugs defined on an underside of the deck. Preferably, the lugs may protrude from one or more of the frame members, preferably at a location at or near the rear edge or midway between the front and rear edges.

Each support arm may be of unitary construction or may be formed from two or more support arm pieces fastened together, preferably the latter.

For example, the elongate body of each support member may be constructed from two body pieces arranged together in a sliding arrangement and configured to fastened together at multiple location so that a length of the support arm may be readily adjusted.

In embodiments in which the deck is pivotally mountable to the rear of the cab, the deck may preferably be pivotable about the front edge so that the rear edge may be pivotable relative to the cab between the operable and stowage positions.

The rear edge of the deck may pivot about any range of movement between the operable and stowage positions. For example, the rear edge may pivot about 45°, about 50°, about 55°, about 60°, about 65°, about 70°, about 75°, about 80° or even about 90°.

In some such embodiments, the deck may be pivotally mountable to one or more brackets and/or support members mounted to the rear of the cab as previously described. For example, the front edge of the deck may be hingedly coupled to the two or more U-brackets.

In other such embodiments, the deck may be supported in the operable position by the one or more support arms extending up from a rear of the cab, preferably at least two support arms, more preferably two support arms extending upwards from the rear of the cab and configured to support an underside of the deck at either side edge of the deck when in the operable position.

In such embodiments, each support arm may be coupled at a first end to a lifting point defined on the rear of the cab and the opposed second end may include an abutment interface for abutting against an underside of the deck when in the operable position. The abutment interface may include a flanged end portion configured to receive and support a lower surface of one or of the frame members or cross frame members of the deck.

In some embodiments, the deck may further include an actuating mechanism for pivoting the deck between the operable and stowage positions. Any suitable type of actuating mechanism may be used.

The actuating mechanism may be manually actuated or by using a drive. Movement may be linear, although non-linear movement such as rotary movement is also envisaged.

For example, if manually actuated, the actuating mechanism may include one or more of a lever, a ram, an operable handle, a cable and pulley arrangement, a cable and winch arrangement, a hinged arrangement or a pivoting arrangement for raising and lowering the deck.

The actuating mechanism may include one or more biasing mechanisms. For example, in some embodiments movement of the deck to the operable position may work against a force of the biasing mechanism and movement of the deck to the stowage position may work under the force of the biasing mechanism. Conversely, in other embodiments, movement of the deck to the operable position may work under the force of the biasing mechanism and movement of the deck to the stowage position may work against the force of the biasing mechanism.

The biasing mechanism may include one or more weights or springs, such as, e.g., coil springs.

If using a drive, the drive may be a hydraulic or pneumatic ram, or an electric motor for pivoting the deck between the operable and stowage positions.

In some embodiments, the actuating mechanism may include one or more linear actuators each extending between the rear of the cab and the deck and each capable of moving between an extended position and a retracted position.

The one or more linear actuators may include a pneumatic ram, a hydraulic ram or a rigid chain actuator (also known as a linear chain actuator, a push-pull actuator, an electric chain actuator, a zip chain actuator or a column forming chain actuator).

In other embodiments, the actuating mechanism may be a servomotor or stepper motor configured to pivot the deck between the stowage and operable positions.

In yet other embodiments, the actuating mechanism may be a manually, pneumatically or electrically powered screw jack or screw motor.

In yet other embodiments, the actuator or actuating mechanism may include a drive motor, such as, e.g., an electric motor or combustion engine, operatively associated with a winch, a cable and at least one pulley.

In some preferred embodiments, the actuating mechanism may be in the form of a hydraulic ram that may extend between the rear of the cab and an underside of the deck for pivoting the deck between positions.

The actuating mechanism may be pivotally coupled to each of the rear of the cab and the deck for pivoting the deck. The actuating mechanism may preferably be pivotally coupled to each of the cab and the deck by mounting brackets respectively located on each.

As indicated, the platform includes at least one guard rail assembly having a lower end pivotally mountable to a rear edge of the deck and an upper edge pivotable relative to the deck.

In embodiments in which the deck is fixed, the at least one guard rail assembly may be pivotable between a stowage position in which the upper end folds against the rear of the cab and an operable position in which the upper end extends substantially upwards from the deck.

Conversely, in embodiments in which the deck is pivotally mountable to a rear of the cab, the at least one guard rail assembly is pivotable relative to the deck between a position in which the upper end extends substantially upwards when the deck is in the operable position and a position in which the at least one guard rail assembly folds against the rear of the cab when the deck is in the stowage position.

The at least one guard rail assembly may be of any suitable size, shape and construction to, in use, function as a barrier. The assembly may be formed from metal, preferably aluminium.

The at least one guard rail assembly may be of unitary construction or may be formed from two or more frame members joined together, preferably the latter.

For example, in some embodiments, the assembly may include at least one guard rail extending above the rear edge of the deck, preferably in a substantially parallel arrangement with the rear edge. The at least one guard rail may be supported above the rear edge by two or more support members extending in a generally vertical orientation between the at least one guard rail and the rear edge.

In some such embodiments, the at least one guard rail assembly may include two or more guard rails extending above the rear edge of the deck, preferably in a substantially parallel arrangement relative to each other and the rear edge. The two or more guard rails may extend substantially parallel to each other in a spaced arrangement. Again, the rails may be supported above the rear edge by two or more support frame members extending in a generally vertical orientation between the rails and the rear edge.

In other embodiments, the at least one guard rail assembly may include at least two guard rails extending substantially parallel to each other in a generally horizontal orientation and joined together by two or more support frame members extending therebetween, preferably in a generally vertical orientation. A lowermost guard rail of the assembly may be pivotally coupled to the rear edge of the deck.

In preferred embodiments, the at least one guard rail may extend above the rear edge of the deck and at least partially above the side edges of the deck.

The guard rails and the support frame members may be joined together using conventional welding techniques and/or with one or more mechanical fasteners.

The guard rails and the support frame members may each be of tubular construction, solid construction, plate construction or any combination thereof, preferably tubular with a substantially circular cross section.

The lower end of the assembly may be pivotally mounted to the rear edge of the deck in any suitable way, preferably via a lower end of the two or more support members.

The upper end of the assembly may pivot about any range of movement between the operable and stowage positions, or relative to the deck. For example, the upper end may pivot about 10°, about 15°, about 20°, about 25°, about 30°, about 35°, about 40°, about 45° or even about 45° from a substantially vertical orientation when in the operable position, preferably between about 20° and about 30°.

In some embodiments, the lower ends of the two or more support members and the rear edge of the deck may be hingedly coupled together by at least one hinge or part thereof such that the at least one guard rail assembly is pivotable relative to the deck, preferably about the axes of the hinges.

In some embodiments, the platform may further include a biasing mechanism or member extending between the at least one guard rail assembly and the deck for biasing movement of the assembly relative to the deck. Any suitable type of biasing mechanism or member may be used. Likewise, the biasing mechanism or member may extend between the at least one guard rail assembly and the deck in any suitable way and at any suitable location.

For example, in some such embodiments, the biasing mechanism or member may extend between the front edge of the deck and a portion of the assembly located between the lower and upper ends and therefore the biasing mechanism or member may bias the at least one guard rail assembly into the stowage position or a folded position relative to the cab of the truck.

In other such embodiments, the biasing mechanism or member may extend between the front edge of the deck and a lower extension portion of one or more of the one or more support members to therefore bias the at least one guard rail assembly into the operable position.

The biasing mechanism or member may preferably be a coil spring, more preferably a tension spring.

In preferred embodiments, the biasing mechanism or member may include one or more tension springs extending underneath the deck between front edge and the lower end of one or more of the support members, preferably from lower end extension frame members extending from the lower end at least partially underneath the deck towards the front edge.

In such embodiments, the guard rail assembly may move to the stowage position against a force of the biasing mechanism or member and to the operable position under the force of the biasing mechanism or member.

In some embodiments, the platform may further include a retaining mechanism for retaining the guard rail assembly in the stowage position against a force of the biasing mechanism or member. Any suitable retaining mechanism may be used.

In some embodiments, the retaining mechanism may include a first part associated with the guard rail assembly and a second part connectable to the first part associated with the deck.

The retaining mechanism may include mateable male and female formations that releasably couple together, such as, e.g., a threaded connection, an interference (snap-fit) connection or a friction fit-type connection.

In some such embodiments, the first part of the retaining mechanism associated with the guard rail assembly may include a male formation configured to be releasably inserted into, or coupled with, a female formation of the second part of the retaining mechanism associated with the deck.

Conversely, in other such embodiments, the first part of the retaining mechanism may include a female formation configured to releasably receive, or be coupled with, a male formation of the second part of the retaining mechanism.

In some embodiments, the retaining mechanism may include a latch and keeper. For example, one of the at least one guard rail assembly and the rear edge of the deck may include the latch and the other of the at least one guard rail assembly and the rear edge of the deck may include the keeper. In such embodiments, the latch may include a bolt slidable relative to the latch for engaging with the keeper.

In preferred such embodiments, the latch may be mounted on the rear edge of the deck and the keeper may be mounted on or near the lower end of one of the support members. Preferably, in such embodiments, the latch may include a spring-loaded bolt.

In use, the spring-loaded bolt may be pulled relative to the latch to disengage the bolt from the keeper operatively associated with the lower end of one of the support members of the at least one guard rail assembly and thereby release the retaining mechanism to enable the at least one guard rail assembly to pivot to the operable position under the force of the biasing mechanism or member.

In some embodiments, the retaining mechanism may include a latch and more than one keeper. For example, the retaining mechanism may include a first keeper configured to engage with the latch when the at least one guard rail assembly is in the operable position and a second keeper configured to engage with the latch when the at least one guard rail assembly is in the stowage position.

Generally, in such embodiments, the first and second keepers may be located side-by-side at the lower end of one of the support members.

In some embodiments, the platform may further include a retaining mechanism for retaining the at least one guard rail assembly in an upright position extending substantially upwards from the deck when the deck is in the operable position, said retaining mechanism including a sliding rod extending laterally underneath the deck and having one or more male formations extending therefrom for engaging with the lower end of at least one of the support members of the at least one guard rail assembly for locking the at least one guard rail assembly in the upright position.

In such embodiments, the retaining mechanism may further include a cable and operable handle arrangement wherein a first end of the cable is operatively associated with the sliding rod and an opposed second end of the cable is operatively associated with an operable handle, said operable handle configured to apply tension to the cable and cause the sliding rod to slide relative to the lower end of the at least one of the support members of the at least one guard rail assembly for engaging and disengaging the one or more male formations with the lower end of the at least one of the support members of the at least one guard rail assembly.

In some embodiments, the platform may further include an actuating mechanism for pivoting the at least one guard rail assembly between the stowage and operable positions, or relative to the deck. Any suitable type of actuating mechanism may be used.

The actuating mechanism may be manually actuated or by using a drive. Movement may be linear, although non-linear movement such as rotary movement is also envisaged.

For example, if manually actuated, the actuating mechanism may include one or more of a lever, a ram, an operable handle, a cable and pulley arrangement, a cable and winch arrangement, a hinged arrangement or a pivoting arrangement for pivoting the guard rail assembly.

The actuating mechanism may work together with, and against, the biasing mechanism or member as previously described.

If using a drive, the drive may include a hydraulic or pneumatic ram, or an electric motor for pivoting the guard rail assembly.

In some embodiments, the actuating mechanism may include one or more linear actuators each extending between the guard rail assembly and the deck and each capable of moving between an extended position and a retracted position.

The one or more linear actuators may include a pneumatic ram, a hydraulic ram or a rigid chain actuator (also known as a linear chain actuator, a push-pull actuator, an electric chain actuator, a zip chain actuator or a column forming chain actuator).

In other embodiments, the actuating mechanism may be a servomotor or stepper motor configured to pivot the deck between the stowage and operable positions.

In yet other embodiments, the actuating mechanism may be a manually, pneumatically or electrically powered screw jack or screw motor.

In yet other embodiments, the actuator or actuating mechanism may include a drive motor, such as, e.g., an electric motor or combustion engine, operatively associated with a winch, a cable and at least one pulley.

In some preferred embodiments, the actuating mechanism may be in the form of a hydraulic ram that may extend between the deck and the guard rail assembly for pivoting the guard rail assembly relative to the deck.

The actuating mechanism may be pivotally coupled to each of the deck and the guard rail assembly for pivoting the guard rail assembly. The actuating mechanism may preferably be pivotally coupled to each of the deck and the guard rail assembly by mounting brackets respectively located on each.

In some embodiments in which the platform includes one or more actuating mechanisms, the platform may further include a controller for controlling operation of the various actuators or actuating mechanisms and thus movement of any one of the deck relative to a rear of the cab and the guard rail assembly relative to the deck.

The controller may be of any suitable size, shape and configuration.

The controller may be a remote controller or may be associated with the platform.

For example, in some embodiments, the controller may be in the form of one or more switches, dials or levers located on or near the platform. The one or more switches, dials or levers may be electrically connected to the one or more actuators or actuating mechanisms.

In other embodiments, the controller may be a remote controller configured to be remotely operated. The remote controller may be a wired remote or a wireless remote. The remote controller may include one or more keys, buttons or dials for controlling various aspects of functionality of the platform, including the one or more actuators or actuating mechanisms.

In some embodiments, the platform may be part of a system further including at least one proximity sensor positioned on or adjacent a rear of the cab of the dump truck for detecting a position of the deck and/or the guard rail assembly relative to the cab and a controller operatively connected to the at least one sensor and configured to receive an output signal from the sensor and determine whether the deck or guard rail assembly is in the operable position. The controller is preferably configured to isolate the dump truck body or tray in a raised position relative to the chassis when the deck or guard rail assembly is in the operable position.

In preferred such embodiments, the proximity sensor and the controller may form part of a proxy switch operatively associated with the circuit controlling raising and lowering of the dump truck body or tray.

According to a third aspect of the present invention, there is provided a method of mounting a foldable access platform to a rear of a cab of a dump truck, said method including:
mounting a deck to the rear of the cab such that the deck extends proudly from the cab; and
pivotally mounting at least one guard rail assembly to a rear edge of the deck such that the at least one guard rail assembly is pivotable relative to the deck between a stowage position in which an upper end of the assembly folds against the rear of the cab and an operable position in which the upper end extends substantially upwards from the deck.

According to a fourth aspect of the present invention, there is provided a method of folding a foldable access platform relative to a rear of a cab of a dump truck to provide clearance for a truck body when in a lowered position, said method including:
pivoting the at least one guard rail assembly to a stowage position in which an upper end of the at least one guard rail assembly pivots relative to the deck towards the rear of the cabin.

According to a fifth aspect of the present invention, there is provided a method of deploying a guard rail assembly of a foldable access platform relative to a rear of a cab of a dump truck to provide clearance for a truck body when in a lowered position, said method including:
optionally raising a truck body of the dump truck to provide space between the truck body and the rear of the cabin; and
pivoting the at least one guard rail assembly of the access platform to an operable position in which an upper end of the assembly extends substantially upwardly from the deck.

According to a sixth aspect of the present invention, there is provided a method of mounting a foldable access platform to a rear of a cab of a dump truck, said method including:
pivotally mounting a deck to the rear of the cab such that the deck is pivotable between an operable position in which the deck extends rearwardly from the cab in a substantially horizontal orientation and a stowage position in which the deck pivots towards the cab to a substantially vertical orientation; and
pivotally mounting at least one guard rail assembly to a rear edge of the deck such that the at least one guard rail assembly having a lower end pivotally mountable to a rear edge of the deck and an upper edge pivotable relative to the deck when the deck pivots between the operable and stowage positions, said upper end configured to extend substantially upwards from the deck when the deck is in the operable position and fold against the rear of the cab when the deck is in the stowage position.

According to a seventh aspect of the present invention, there is provided a method of folding a foldable access platform relative to a rear of a cab of a dump truck to provide clearance for a truck body when in a lowered position, said method including:
pivoting the deck to a stowage position in which the deck pivots towards the cab to a substantially vertical orientation; and
pivoting the at least one guard rail assembly relative to the deck so that the upper end of the at least one guard rail is folded against the rear of the cabin.

According to an eighth aspect of the present invention, there is provided a method of deploying a guard rail assembly of a foldable access platform relative to a rear of a cab of a dump truck to provide clearance for a truck body when in a lowered position, said method including:

### Optionally Raising a Truck Body of the Dump Truck to Provide Space Between the Truck

body and the rear of the cabin; and pivoting the deck of the access platform to an operable position in which the deck extends rearwardly from the cab in a substantially horizontal orientation; and pivoting the at least one guard rail assembly relative to the deck such that the upper end of the assembly extends substantially upwards from the deck.

The methods may include one or more characteristics or features of the apparatus and mechanism as hereinbefore described.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is a photograph showing an upper perspective view of a foldable access platform in an operable position for accessing a rear of a cab of a dump truck according to an embodiment of the present invention;

FIG. 2 is another photograph of the foldable access platform as shown in FIG. 1 save that the platform is shown in a stowage position;

FIG. 3 is a photograph of the foldable access platform as shown in FIGS. 1 and 2 fitted to a dump truck with its tray body shown in the lowered position;

FIG. 4 is a photograph showing a magnified image of the image shown in FIG. 3;

FIG. 5 is a photograph showing a side view of a support supporting a deck of the platform relative to the cab of the truck;

FIG. 6 is a photograph showing a biasing mechanism of the foldable access platform shown in any one of FIGS. 1 to 5 for biasing a guard rail assembly relative to a deck of the platform to the operable position;

FIG. 7 is a photograph showing a retaining mechanism of the platform assembly for retaining the guard rail assembly of the platform relative to the deck in any one of the operable and stowage positions;

FIG. 8 is a rear upper perspective view of a foldable access platform in an operable position according to another embodiment of the present invention;

FIG. 9 is a forward upper perspective view of the foldable access platform shown in FIG. 8;

FIG. 10 is a rear upper perspective of the foldable access platform shown in FIGS. 8 and 9 in the stowage position;

FIG. 11 is a forward upper perspective view of the foldable access platform as shown in FIG. 10; and

FIG. 12 is a lower perspective view of a foldable access platform in the operable position according to another embodiment of the present invention.

### DETAILED DESCRIPTION

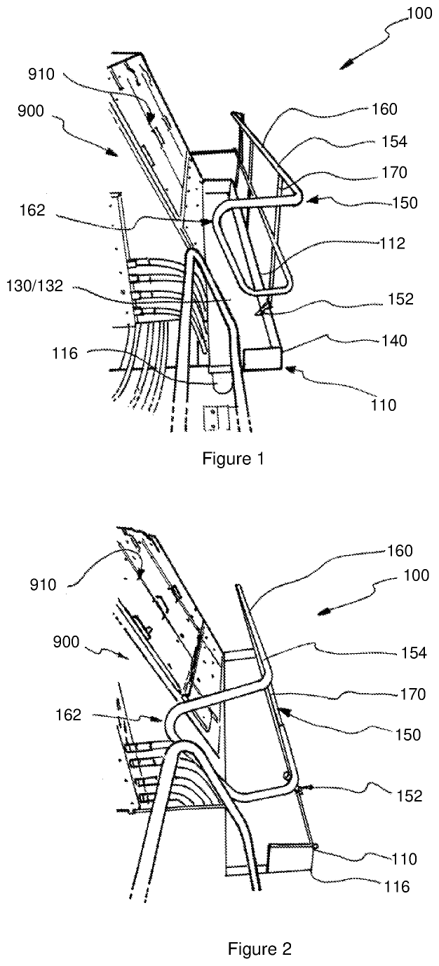

FIGS. 1 to 12 show embodiments and parts of a foldable access platform (100) for accessing a rear of a cab (910; shown in FIGS. 1-4 only) of a dump truck (900; shown in FIGS. 1-4 only).

FIGS. 1 to 7 show a first embodiment of the foldable access platform (100).

Referring to FIGS. 1 and 2, the platform (100) includes a deck (110) extending rearwardly from a rear of the cab (910) of a dump truck (900); and a guard rail assembly (150) having a lower end (152) pivotally mountable to a rear edge (112) of the deck (110) and an upper end (154) pivotable between a stowage position, shown in FIG. 2, in which the upper end (154) is folded against the rear (910) of the cab (900) and an operable position, shown in FIG. 1, in which upper end (154) extends substantially upwards from the deck (110).

As indicated above, the foldable access platform (100) is for use in accessing a rear of a cab (910) of a dump truck (900), preferably haul trucks or rigid dump trucks (e.g., Komatsu™ HD1500 or Liebherr™ T236, T264, T274 or T284).

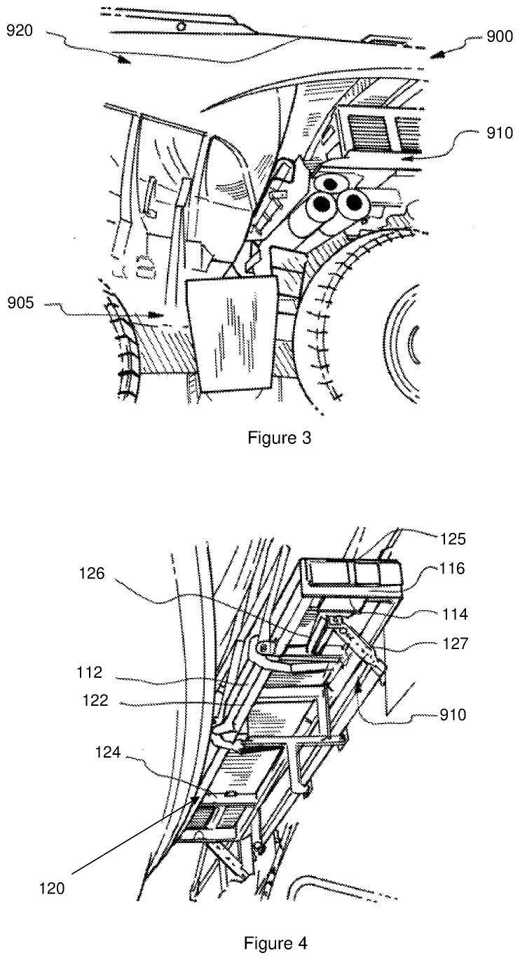

Referring briefly to FIG. 3, generally such dump trucks (900) include a chassis (905), a cab (910) and a dump truck body or tray (920) hingedly coupled to the chassis (905) and configured to be pivotable between a lowered position (shown) for receiving and transporting materials and a raised position for unloading the materials.

Referring back to FIG. 1, the deck (110) is formed from aluminium. The deck (110) includes a deck frame (120; not visible) and a panel (130) mounted atop the frame (120; not visible).

Referring briefly to FIG. 4, the deck frame (120) has a rectangular shape. The frame (120) include a front edge (114), an opposed rear edge (112) and opposed side edges (116). The front and rear edges (112, 114) extend longitudinally between the opposed side edges (116).

The deck frame (120) defines an upper surface (125) and an opposed lower surface (127). The panel (130) is mounted atop the upper surface (125).

The deck frame (120) formed from frame members joined together. Specifically, the frame (120) includes a pair of longitudinally extending frame members (122) defining the front and rear edges (112, 114) and extending between the opposed side edges (116). The longitudinally extending frame members (122) are joined together by six transversely extending cross frame members (124) with the outermost cross frame members (124) defining the opposed side edges (116). As shown, the frame (120) further includes two frame member (126) extending parallel to the longitudinally extending frame members (122) between the outermost cross frame members (124) and adjacent cross frame members (124).

The various frame members (122, 124, 126) are joined together using conventional welding techniques.

The frame members (122, 124, 126) are each of a tubular construction with a substantially rectangular cross section.

Referring back to FIG. 1, the deck (110) has an elongate rectangular shape configured to extend width wise across a rear of the cab (910) of the dump truck (900).

The panel (130) mounted atop the deck frame (120; not visible) is joined to the frame members (122, 124, 126; not visible) using conventional welding techniques fasteners.

The upper surface (132) of the panel (130) includes a textured tread to provide grip.

The deck (110) further includes a guard (140) extending upwardly from and extending at least partially about the opposed side edges (116) and the rear edge (112). The guard (140) advantageously prevents any items inadvertently rolling or sliding over the rear and/or side edges (112, 116) of the deck (110).

The guard (140) includes one or more sheets of aluminium sheeting extending upwards from the opposed side edges (116) and the rear edge (112) to a height of about 100 mm.

Like the frame members (122, 124, 126; not visible) and the panel (130), the guard (140) is joined to the opposed side edges (116) and the rear edge (112) of the deck (110) using conventional welding techniques. a rear of the cab (910) using various support arms and brackets extending between the rear of the cab (910) and an underside of the deck (110).

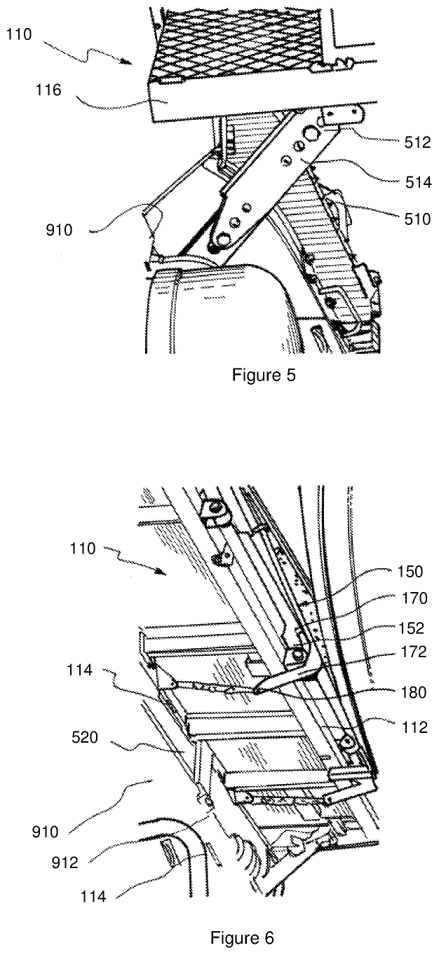

For example, and with reference to FIG. 5, the deck (110) includes a pair of support arms (510) extending between the rear of the cab (910) and an underside of the deck (110) at either side edge (116) of the deck (110).

Each support arm (510) includes a pair of opposed ends (512) and an elongate body (514) extending therebetween.

Each end (512) is configured to be pivotally coupled to mounting points defined on the rear of the cab (910) and the underside of the deck (110). The mounting point defined on the rear of the can (910) dually functions as a lifting point. Likewise, the mounting point defined on the underside of the deck (110) includes a pair of lugs.

The elongate body (514) of each support member (510) is constructed from two body pieces arranged together in a sliding arrangement and configured to be fastened together at multiple location so that a length of the support arm (510) is readily adjustable. Advantageously, this assists the support arms (510) to be used with decks (110) of differing widths.

Referring to FIG. 6, and in addition to the aforementioned support arms (510), the deck (110) is additionally mounted to the rear of the cab (910) by at least two U-brackets (520) extending downwardly from, and spaced along, the front edge (114) of the deck (110) and configured to sit atop a support member (912) extend across the rear of the cab (910). The support member (912) is in the form of beam, such as, e.g., a control box brace.

The distal open ends of each U-bracket (520) extend beyond the support member (912) and are fastened about the support member (912) with a mechanical fastener or the like.

Referring back to FIGS. 1 and 2, the guard rail assembly (150) be pivotable between an operable position, as shown in FIG. 1, in which the upper end (154) extends substantially upwards from the deck (110) and a stowage position, as shown in FIG. 2, in which the upper end (154) folds against the rear of the cab (910) (so as to not clash with a forward surface of the dump truck body or tray (920) as shown in FIG. 3).

The guard rail assembly (150) is constructed from aluminium and includes two guard rails (160) extending substantially parallel to each other in a generally horizontal orientation above and parallel to the rear edge (112) of the deck (110) and three support members (170) joining the guard rails (160) together and supporting them above the rear edge (112). The three support members (170) are spaced along the rear edge (112) of the deck (110) and each extending in a generally vertical orientation between the guard rails (160) and the rear edge (112).

As shown, the wings (162), or outer ends of the guard rails (160) extend around and at least partially above the side edges (116) of the deck (110).

The guard rails (160) and the support frame members (170) are joined together using conventional welding techniques.

The guard rails (160) and the support frame members (170) are each be of tubular construction with a substantially circular cross section.

Referring to FIG. 6, the lower end (152) of the assembly (150), which correspond to the lower ends of the respective support frame members (170), are pivotally mounted to the rear edge (112) of the deck (110).

Generally, the lower end of each support frame member (170) includes a bearing and the rear edge (112) of the deck (110) includes three respective mounting points to which the bearings are respectively pinned. Each mounting point includes a pair of outwardly protruding mounting plates to which the bearing is pinned with a pivot pin.

When mounted, the guard rail assembly (150) pivots relative to the deck (110) about the axes of the pivot pins. The respective support frame members (170) are pivotally mounted in such a way as to enable the upper end (154; not visible) of the assembly (150) to pivot about a range of movement of between about 20° and about 30° between the operable and stowage positions.

The platform (100) further includes a biasing mechanism or member extending between the guard rail assembly (150) and the deck (110) for biasing movement of the assembly (150) to the operable position.

Specifically, the biasing mechanism or member extend between the front edge (114) of the deck and a lower extension portion (172) of each of the support frame members (170) to therefore bias the assembly (150) into the operable position. The biasing mechanism or member is in the form of a tension spring (180).

In such embodiments, the guard rail assembly (150) moves to the stowage position against a force of the biasing mechanism or member and to the operable position under the force of the biasing mechanism or member.

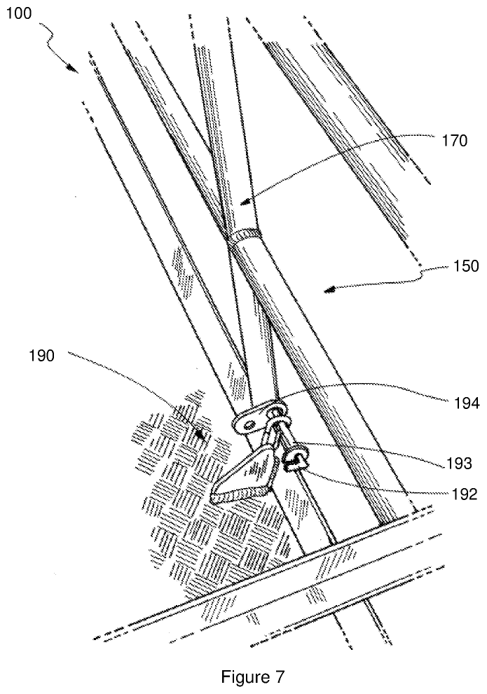

Referring to FIG. 7, the platform (100) further includes a retaining mechanism (190) for retaining the guard rail assembly (150) in the stowage position against a force of the biasing mechanism or member and in the operable position.

As shown, the retaining mechanism (190) includes a latch (192) having a spring-loaded bolt (193) mounted on the rear edge (112) of the deck (110) and a keeper (194) mounted on or near the lower end of one of the support frame members (170). The keeper (194) includes two openings configured to receive the spring-loaded bolt (193). The openings correspond to the operable and stowage positions.

In use, the spring-loaded bolt (193) is pulled relative to the latch (192) to disengage the bolt (193) from the keeper (194) operatively associated with the lower end of one of the support members (170) of the guard rail assembly (150) and thereby release the retaining mechanism (190) to enable the guard rail assembly (150) to pivot between the operable and stowage positions.

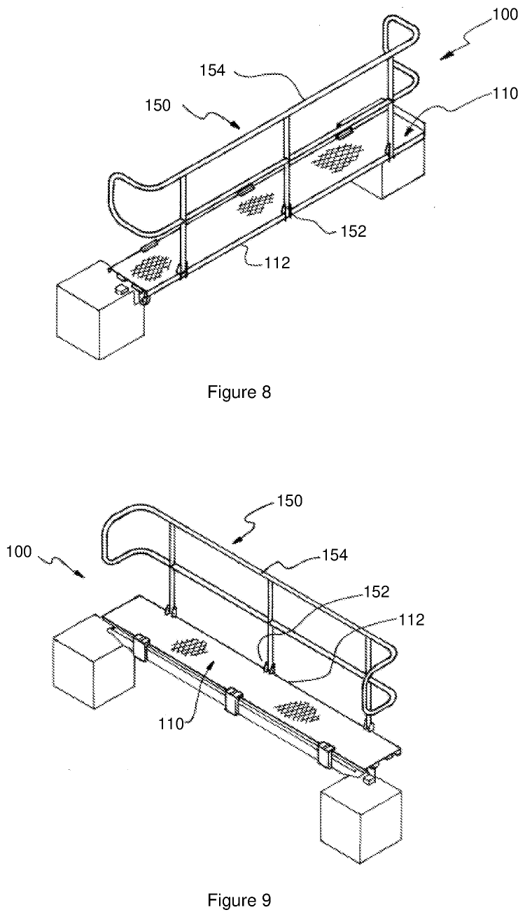

FIG. 8 to 11 show a second embodiment of the foldable access platform (100). For convenience, features that are similar or correspond to features of the first embodiment will again be referenced with the same reference numerals.

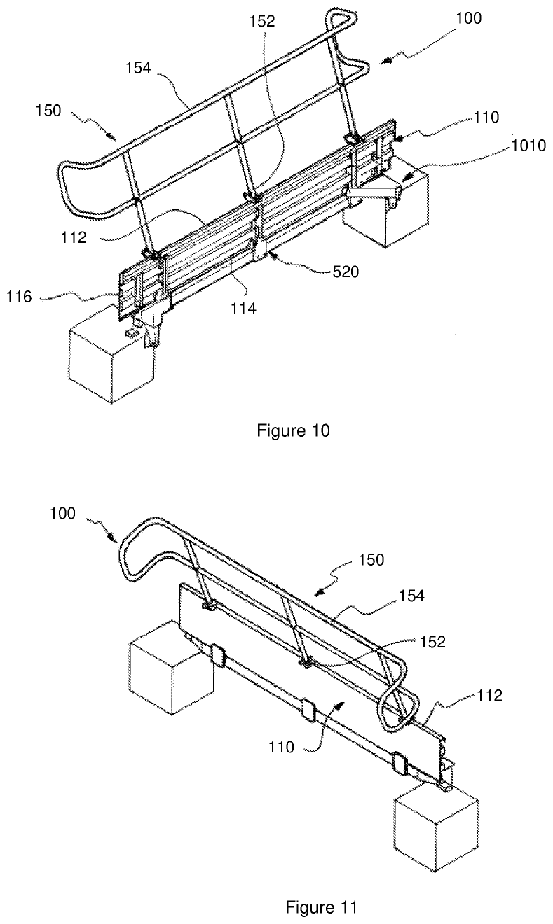

Referring to FIGS. 8 to 11, the foldable access platform (100) includes a deck (110) pivotally mountable to a rear of the cab (910; not shown), said deck (110) being pivotable between an operable position in which the deck extends rearwardly from the cab (910; not shown) in a substantially horizontal orientation, as shown in FIGS. 8 and 9, and a stowage position in which the deck pivots upwards towards the cab (910; not shown) to a substantially vertical orientation, as shown in FIGS. 10 and 11.

The platform (100) further includes a guard rail assembly (150) having a lower end (152) pivotally mountable to a rear edge (112) of the deck (110) and an upper edge (154) pivotable relative to the deck (110) when the deck (110) pivots between the operable and stowage positions. The upper end (154) is configured to extend substantially upwards from the deck (110) when the deck (110) is in the operable position, as shown in FIGS. 8 and 9, and fold against the rear of the cab (910; not shown) when the deck (110) is in the stowage position, as shown in FIGS. 10 and 11.

Referring to FIG. 10, the deck (110) is pivotally mounted to the rear of the cab (910; not shown) along the front edge (114) so that the rear edge (112) of the deck (110) is pivotable relative to the cab (910; not shown) between the operable and stowage positions.

The rear edge (112) of the deck (110) pivots about a range of movement of about 90° between the operable and stowage positions.

Like the first embodiments, the deck (110) is pivotally mountable to the cab (910; not shown) via one or more U-brackets (520) as previously described.

Specifically, and as shown, the front edge (114) of the deck (110) is hinged coupled to three U-brackets (520). Further, the deck (110) is supported in the operable position by at least two supports (1010) located at or near either side edge (116) of the deck (110). Each support (1010) includes an abutment interface configured to receive and support a lower surface of the deck (110) when in the operable position.

Referring to FIG. 11, the lower ends of the respective support frame members (170) are pivotally mounted to the rear edge (112) of the deck (110) so that the guard rail assembly (150) is pivotable relative to the deck (110).

Specifically, and as with the first embodiment, the lower end of each support frame member (170) includes a bearing and the rear edge (112) of the deck (110) includes three respective mounting points to which the bearings are respectively pinned. Each mounting point includes a pair of outwardly protruding mounting plates to which the bearing is pinned with a pivot pin.

When mounted, the guard rail assembly (150) pivots relative to the deck (110) about the axes of the pivot pins. The respective support frame members (170) are pivotally mounted in such a way as to enable the upper end (154) of the assembly (150) to pivot about a range of movement of between about 70° and about 85° between the operable and stowage positions.

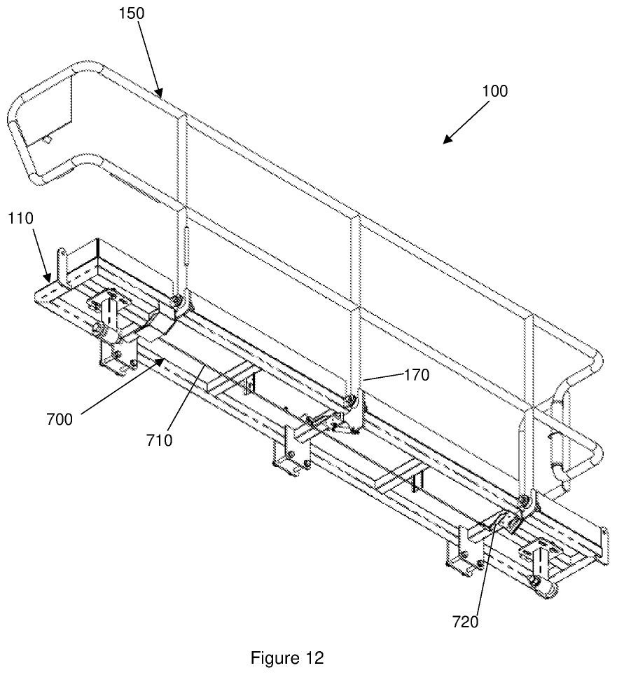

FIG. 12 shows a third embodiment of the foldable access platform (100). For convenience, features that are similar or correspond to features of the first embodiment will again be referenced with the same reference numerals.

In this embodiments, the platform (100) further includes a retaining mechanism (700) for retaining the guard rail assembly (150) in an upright position extending substantially upwards from the deck (110) when the deck (110) is in the operable position.

The retaining mechanism (700) includes a sliding rod (710) extending laterally underneath the deck (110) and having one or more male formations (720) extending therefrom for engaging with the lower end of each support frame member (170) of the guard rail assembly (150) for locking the guard rail assembly (150) in the upright position.

The retaining mechanism further includes a cable and operable handle arrangement (not shown) wherein a first end of the cable is operatively associated with the sliding rod (710) and an opposed second end of the cable is operatively associated with an operable handle. The operable handle configured to apply tension to the cable and cause the sliding rod (710) to slide relative to the lower end of the support members (170) of the guard rail assembly (150) for engaging and disengaging the one or more male formations (720) with the lower end of the support frame members (170) of the guard rail assembly (150).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A foldable access platform for accessing a rear of a cab of a dump truck, said platform comprising:
a deck extending rearwardly from the rear of the cab, said deck having a front edge and an opposed rear edge; and
at least one guard rail assembly comprising two or more guard rails extending above the rear edge of the deck in a substantially parallel arrangement relative to each other and supported by two or more support frame members extending between the rails and the rear edge of the deck, said two or more support frame members having a lower end pivotally coupled to the rear edge of the deck such that the at least one guard rail assembly is pivotable relative to the deck and an upper end of the at least one guard rail assembly is pivotable between a stowage position in which the upper end is folded against the rear of the cab and an operable position in which the upper end extends substantially upwards from the deck;
a biasing mechanism comprising one or more tension springs extending underneath the deck between the front edge of the deck and a lower extension portion of at least one of the at least two or more support frame members for biasing the at least one guard rail assembly into the operable position, said lower extension portion extending beyond the lower end of the two or more support frame members pivotally coupled to the rear edge; and
a retaining mechanism for retaining the guard rail assembly in the stowage position against a force of the biasing mechanism.

2. The platform of claim 1, wherein the deck comprises a deck frame and a one or more panels mounted atop the deck frame.

3. The platform of claim 2, wherein the one or more panels are formed of steel mesh.

4. The platform of claim 1, wherein the deck is fixedly mountable to the rear of the cab.

5. The platform of claim 4, wherein the deck is fixedly mountable to the rear of the cab by two or more U-brackets extending down from an underside of the deck and configured to sit atop a support member extending across a rear of the cab.

6. The platform of claim 1, wherein the deck is pivotally mountable to the rear of the cab, said deck being pivotable between an operable position in which the deck extend rearwardly from the cab in a substantially horizontal orientation and a stowage position in which the deck pivots towards the cab to a substantially vertical orientation.

7. The platform of claim 6, wherein the upper end of the at least one guard rail assembly is configured to extend upwards from the deck when the deck is in the operable position and fold against the rear of the cab when the deck is in the stowage position.

8. The platform of claim 7, wherein the deck is pivotable a range of movement between the operable and stowage positions of about 90°.

9. The platform of claim 6, further comprising an actuating mechanism for pivoting the deck between the operable and stowage positions.

10. The platform of claim 9, wherein the actuating mechanism comprises a hydraulic ram extending between the rear of the cab and an underside of the deck for pivoting the deck between the operable and stowage positions.

11. (canceled)

12. The platform of claim 6, wherein the at least one guard rail is pivotable relative to the deck between a position in which the upper ends extends substantially upwards when the deck is in the operable position and a position in which the at least one guard rail assembly folds against the rear of the cab when the deck is in the stowage position.

13. The platform of claim 12, wherein the upper end of the at least one guard rail assembly pivots about a range of movement of between about 20° and about 30°.

14-16. (canceled)

17. The platform of claim 1, wherein the retaining mechanism comprises a spring-loaded bolt mounted on a rear edge of the deck and a keeper for engaging with the spring-loaded bolt mounted on or near a lower end of the two or more support members for retaining the spring-loaded bolt and retaining the at least one guard rail assembly in the stowage position.

18. The platform of claim 6, wherein the retaining mechanism comprises a retaining mechanism for retaining the guard rail assembly in an upright position extending substantially upwards from the deck when the deck is in the operable position, said retaining mechanism comprising a sliding rod extending laterally underneath the deck and having one or more male formations extending therefrom for engaging with the lower end of at least one of the support members of the at least one guard rail assembly for locking the at least one guard rail assembly in the upright position.

19. The platform of claim 18, wherein the retaining mechanism further comprises a cable and operable handle arrangement wherein a first end of the cable is operatively associated with the sliding rod and an opposed second end of the cable is operatively associated with an operable handle, said operable handle configured to apply tension to the cable and cause the sliding rod to slide relative to the lower end of the at least one of the support frame members of the at least one guard rail assembly for engaging and disengaging the one or more male formations with the lower end of the at least one of the support members of the at least one guard rail assembly.

20. A method of folding a foldable access platform relative to a rear of a cab of a dump truck to provide clearance for a truck body when in a lowered position, said method comprising:
providing the foldable access platform according to claim 1, and
pivoting the at least one guard rail assembly to a stowage position in which an upper end of the at least one guard rail assembly pivots relative to the deck towards the rear of the cabin.

21. The method of claim 20, further comprising:
providing the foldable access platform of claim 6;
pivoting the deck to a stowage position in which the deck pivots towards the cab to a substantially vertical orientation; and
pivoting the at least one guard rail assembly relative to the deck so that the upper end of the at least one guard rail is folded against the rear of the cabin.
